(19) United States
(12) Patent Application Publication
(10) Pub. No.: US 2010/0275154 A1
(43) Pub. Date: Oct. 28, 2010

(54) System and Method For Securely Presenting Data

(76) Inventor: Noam Livnat, Ramot - Meir (IL)

Correspondence Address: The Law Office of Michael E. Kondoudis, 888 16th Street, N.W., Suite 800, Washington, DC, 20006, US

(21) Appl. No.: 12/730,418

(22) Filed: Mar. 24, 2010

Related U.S. Application Data
(60) Provisional application No. 61/171,995, filed on Apr. 23, 2009.

(51) Int. Cl. G06F 3/048

(52) U.S. Cl. 715/802; 715/781

(57) ABSTRACT

An apparatus for securely presenting data to a user, the apparatus comprising: a data receiver, configured to receive the data, and a data presenter, associated with the data receiver, configured to present the received data to the user on a screen, through a graphical user interface comprising a first part exposing only a portion of the presented data and a second part disabling free viewing of a remaining portion of the presented data.

### RELATIONSHIP TO EXISTING APPLICATIONS

The present application claims priority from U.S. Provisional Patent Application No. 61/171,995 filed on Apr. 23, 2009, the contents of which are hereby incorporated by reference.

### FIELD AND BACKGROUND OF THE INVENTION

The present invention relates to data security and, more particularly, but not exclusively, to a system and method for securely presenting data to a user.

Businesses, organizations, individuals, and other entities, currently rely on internet web sites, e-mail messages, etc., to distribute data files. The distributed data files may carry sensitive content, such as classified data or copyright protected content, to users.

Usually, when the sensitive content is received by a user, the sender has virtually no control over the redistribution or use of the sensitive content.

Consequently, organizations, such as financial institutions, marketing organizations, organizations in the field of Intellectual Property, government institutions, armies, etc., face multiple challenges when it comes to sharing and protecting documents and information.

For example, senior management residing in different locations needs to have access to highly confidential information, while stringent access control needs to be applied to sensitive customer data, so that data leakage, whether intentional or a result of human error, is avoided.

In recent years, many solutions have been introduced, to address the problem of data leakage.

For example, a US Patent Application, Publication No. 20020069365, to Howard et al, filed on Sep. 10, 1999, entitled “Limited Use Browser and Security System”, as described in the application abstract section, introduces a limited-use browser and a related security system.

The security system, as described by Howard, secures the content on the server and only permits the content to be downloaded to a client computer running the limited-use browser or a general purpose browser executing an add-in security module providing the same functions as the limited-use browser.

The limited-use browser or module secures the downloaded content on the client computer and displays the content in a view-only mode.

While the secured content is being displayed, menu selections, key combination, or pointing device commands initiated on the client computer that would modify the content or create a copy on another medium, are either disabled as a default or monitored to determine if the action is permitted.

In another example, US Patent Application, Publication No. 20020150239, to Carny et al, filed on Apr. 16, 2002, entitled “Method for personalized encryption in an un-trusted environment”, as described in the abstract section, introduces an idea of preventing illegal copying and distribution of digital content.

Carny proposes to prevent illegal copying of the digital content, using real-time personalized encryption of digital content.

Carny's method is carried out by selecting one or more segments of a digital content to be protected.

Then, the selected segments are duplicated. Finally, there is created a plurality of copies of each segment and a different encryption is preformed on each of the different copies.

In yet another example, US Patent Application, Publication No. 20050204130, to Harris, filed on Mar. 10, 2004, entitled “Computer program for securely viewing a file”, as described in the abstract section, introduces a method for distributing a password protected content file without revealing the password to a recipient.

Harris further describes an unlocking program that has access to one or more passwords. The passwords correspond to the password protecting the content file distributed to the recipient's computer.

Then, a password protected content file is distributed to the recipient's computer.

Upon activation of the unlocking program, the unlocking program automatically supplies the password upon loading of the password protected content file.

Currently used systems aim at protecting sensitive data (say copy right protected content or classified information), by disabling, restricting or monitoring computer operations carried out on the recipient's computer.

That is to say that the currently used systems are limited to protecting against data leakage through unauthorized computer operations, such as file copying, file opening, menu selections, cut and paste operations, printing, e-mail forwarding, etc.

There is thus a widely recognized need for, and it would be highly advantageous to have, a system and method devoid of the above limitations.

### SUMMARY OF THE INVENTION

According to one aspect of the present invention there is provided an apparatus for securely presenting data to a user, the apparatus comprising: a data receiver, configured to receive the data, and a data presenter, associated with the data receiver, configured to present the received data to the user on a screen, through a graphical user interface comprising a first part exposing only a portion of the presented data and a second part disabling free viewing of a remaining portion of the presented data.

According to a second aspect of the present invention there is provided a computer implemented method for securely presenting data to a user, the method comprising steps the computer is programmed to perform, the steps comprising: receiving the data, and presenting the received data to the user on a screen, through a graphical user interface comprising a first part exposing only a portion of the presented data and a second part disabling free viewing of a remaining portion of the presented data.

According to a third aspect of the present invention there is provided a computer readable medium storing computer executable instructions for performing steps of securely presenting data to a user, the steps comprising: receiving the data, and presenting the received data to the user on a screen, through a graphical user interface comprising a first part exposing only a portion of the presented data and a second part disabling free viewing of a remaining portion of the presented data.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof.

Moreover, according to actual instrumentation and equipment of preferred embodiments of the method and system of the present invention, several selected steps could be implemented by hardware or by software on any operating system of any firmware or a combination thereof.

For example, as hardware, selected steps of the invention could be implemented as a chip or a circuit.

As software, selected steps of the invention could be implemented as a plurality of software instructions being executed by a computer using any suitable operating system.

In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. The description taken with the drawings making apparent to those skilled in the art how the several forms of the invention may be embodied in practice.

In the drawings:

FIG. 1 is a block diagram schematically illustrating a first exemplary apparatus, for securely presenting data to a user, according to an exemplary embodiment of the present invention.

FIG. 2 is a block diagram schematically illustrating a second exemplary apparatus, for securely presenting data to a user, according to an exemplary embodiment of the present invention.

FIG. 3 is a flowchart schematically illustrating a first exemplary method, for securely presenting data to a user, according to an exemplary embodiment of the present invention.

FIG. 4 is a flowchart schematically illustrating a second exemplary method for securely presenting data to a user, according to an exemplary embodiment of the present invention.

FIG. 5 is a block diagram schematically illustrating a computer readable medium storing computer executable instructions for performing steps of securely presenting data to a user, according to an exemplary embodiment of the present invention.

FIG. 6 is a block diagram schematically illustrating a first exemplary Graphical User Interface, for securely presenting data to a user, according to an exemplary embodiment of the present invention.

FIG. 7 is a block diagram schematically illustrating a second exemplary Graphical User Interface, for securely presenting data to a user, according to an exemplary embodiment of the present invention.

FIG. 8 is a block diagram schematically illustrating a third exemplary Graphical User Interface, for securely presenting data to a user, according to an exemplary embodiment of the present invention.

FIG. 9 is a block diagram schematically illustrating a fourth exemplary Graphical User Interface, for securely presenting data to a user, according to an exemplary embodiment of the present invention.

FIG. 10 is a block diagram schematically illustrating a fifth exemplary Graphical User Interface, for securely presenting data to a user, according to an exemplary embodiment of the present invention.

### DESCRIPTION OF THE PREFERRED EMBODIMENTS

The present embodiments comprise an apparatus and method for securely presenting data to a user.

One of the ways sensitive data may be copied without authorization, and thus leak, is through computer screen capturing.

An apparatus according to an exemplary embodiment of the present invention may minimize data leakage through computer screen capturing.

The apparatus may minimize data leakage through an image of computer screen, as captured using a device external to the computer, such as a pocket still camera, a cellular phone camera, etc.

Data leakage through an image of computer screen, as captured using a device external to the computer, escapes traditional data security mechanisms. The traditional data security mechanisms are limited to operations on the computer itself (i.e. to computer operations initiated by a user, to computer operations performed by spying software, etc., as known in the art).

According to exemplary embodiments of the present invention, data (say textual content of a Microsoft© Word file, graphical content of an electronic circuit diagram on a graphical file, etc.) is presented to a user on a screen, through a special Graphical User Interface (GUI).

The screen may be a desktop computer screen, a laptop computer screen, a screen of a tablet computer, a cellular phone screen, etc, as known in the art.

The special GUI includes a first part. The first part exposes only a portion of the data presented on the screen, say only two lines of text at a time.

The special GUI further includes a second part. The second part disables free viewing of a remaining portion of the data presented on the screen.

The free viewing of the remaining portion of the data may be prevented by blurring the remaining portion, hiding the remaining portion (fully or partially), etc., as described in further detail hereinbelow.

For example, the free viewing of the remaining portion of the data may be carried out using one or more geometrical figures, such as spaced prison-like bars. The bars partially hide the remaining portion of the data presented on the screen, as described in further detail, and illustrated hereinbelow.

Consequently, an image of a computer screen used to present the data, as captured using a device external to the computer (say a still camera), shows only a portion of the data presented on the screen.

Further, a hiding or blurring effect applied on the remaining portion of the data presented on the screen, may serve as incriminating evidence against a person in possession of an image of the screen, as captured by the still camera, as described in further detail hereinbelow.

The principles and operation of a system and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings

The invention is capable of other embodiments or of being practiced or carried out in various ways. Also, it is to be understood that the phraseology and terminology employed herein is for the purpose of description and should not be regarded as limiting.

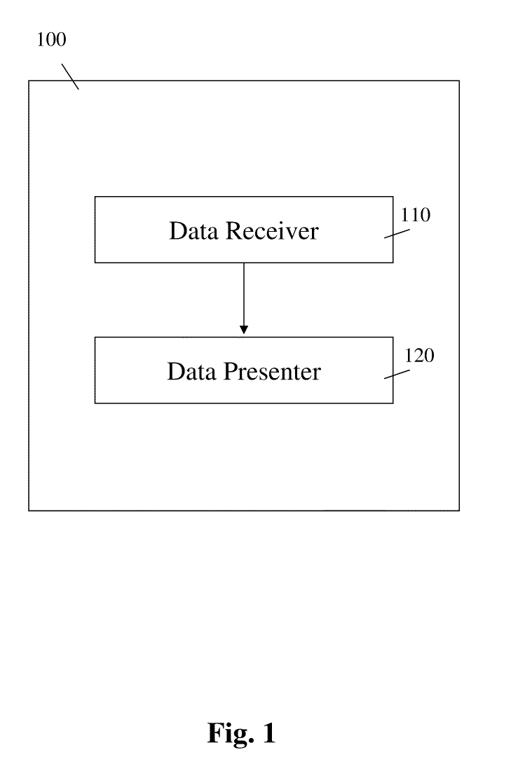

Reference is now made to FIG. 1, which is a block diagram schematically illustrating a first exemplary apparatus, for securely presenting data to a user, according to an exemplary embodiment of the present invention.

Apparatus 100 for securely presenting data to a user may be implemented as a computer program installed on a user's computer (say a desktop computer, a laptop computer, a tablet computer, a cellular phone, etc).

The apparatus 100 may also be implemented as a part of a computer program installed on the user's computer. For example, the apparatus 100 may be implemented as a plug-in to Microsoft© Word, which hooks certain Microsoft© Word events or Microsoft© Windows events, as known in the art.

The apparatus 100 may also be implemented as a server application in remote communication with a dedicated client program installed on the user's computer, or as a part thereof, as known in the art.

The apparatus may also be implemented in a Software-as-a-Service (SaaS) mode, as known in the art.

In one exemplary SaaS model, the apparatus 100 is implemented on a server remote from the user. The user communicates with apparatus 100, using a standard internet browser (say Microsoft© Internet Explorer, Google© Chrome, etc.), without a dedicated client program, as described in further detail hereinbelow.

In a second SaaS model, the apparatus 100 is implemented as a part of a secure flash application downloadable to a standard internet browser (say to a Microsoft© Internet Explorer browser, Google© Chrome browser, etc.), as described in further detail hereinbelow.

The exemplary SaaS models may prove very suitable, for an organization which limits installation of client software on the organization's computers. The exemplary SaaS models also suit users of software or hardware platforms not compatible with a dedicated client program provided by a vendor of the apparatus 100, for remotely communicating with the apparatus 100. Apparatus 100 includes a data receiver 110.

The data receiver 110 receives data, say by e-mail or from a local folder, as selected by a user who chooses a document from the folder, etc., as known in the art.

The data may include, but is not limited to: textual data (say content of a Microsoft© Word file), graphical content (say an electronic circuit diagram or a computer flowchart on a graphical file), etc.

The apparatus 100 further includes a data presenter 120, in communication with the data receiver 110.

The data presenter 120 presents the received data to the user, on a screen (say a computer screen, a cellular phone screen, etc.), through a graphical user interface.

The graphical user interface includes a first part. The first part exposes only a portion of the presented data.

The graphical user interface also includes a second part. The second part disables free viewing of one or more remaining portions of the received data.

Consequently, the apparatus 100 may prevent data-leakage by screen-capture, as described in further detail hereinbelow.

Optionally, the first part is movable through the presented data and a user who views the presented data may operate the data presenter 120, for moving the first part, thereby exposing a different portion of the presented data through the first part.

Optionally, a remote user, say an authorized administrator, or a publisher of the data presented on the screen, may operate the data presenter 120, for moving the first part, as described in further detail hereinbelow.

Optionally, the first part moves between positions on the screen. Alternatively, the first part moves through the presented data while staying in a fixed position on the screen, thus scrolling through the presented data.

As the first part moves through different portions of the presented data, the first part exposes different portions of the presented data on the computer screen. The second part disables free viewing of the remaining portion of the data presented on the screen.

That is to say that the first part exposes only a portion of the presented data at a time. The exposed portion is freely viewable by the user, through the first part, while the presented data's remaining portion is obfuscated or obscured.

Optionally, the remaining portion is obfuscated or obscured by a concealing or blurring effect, caused by the second part of the graphical user interface. Consequently, the second part prevents free viewing of the remaining portion, as described in further detail hereinbelow.

Optionally, the data presenter 120 automatically moves the first part, for exposing different portions of the data presented on the screen. Further, the data presenter 120 may be operated by the user, for controlling movement of the first part. For example, the user may use arrow keys to control the direction of the first part, press a certain key to slow down or speed up the first part, press a tab key to jump over a portion of the presented data, etc.

Optionally, upon a successful string search operation initiated by the user (as known in the art), the data presenter 120 relocates the first part. Consequently, the first part exposes a portion of the presented data, in proximity of the string.

For example, the data presenter 120 may be implemented as a plug-in to a Word Processor, say to Microsoft© Word. Upon a successful search for a specific string in a document, say a Word (.doc) document, the data presenter 120 automatically moves the first part through the document, into a position in proximity to the string, as found in the document. The first part exposes text in proximity of the found string, while the second part blurs the remaining text of the document, as described in further detail hereinbelow.

The amount of data exposed by the first part may be limited by the size and shape of the first part, as described in further detail and illustrated hereinbelow.

For example, the first part may be oval, rectangular, etc. The first part may be limited to a fixed physical size, to an amount of data (say number of bytes or number of text lines) the first part exposes, etc.

Optionally, the apparatus 100 further includes a data structure deriver, in communication with the data receiver 110.

The data structure deriver derives a structure of the received data. The data presenter 120 may be operated by the user, for moving the first part through a path. The path is based on the structure derived by the data structure deriver.

For example, the data structure deriver may derive the structure of a textual file bearing the content of a classified intelligent report, by detecting changes in fonts. The font changes may be characteristic of headlines of articles in the classified intelligent report. Consequently, the data presenter 120 may be operated by the user, for moving the first part between the articles in the classified intelligent report.

Optionally, the data presenter 120 further dynamically changes the first part, according to the article presented through the first part.

For example, the data presenter 120 may dynamically adjust the size and shape of the first part of the GUI, according to the article exposed through the first part. When the first part moves from a first article to a second article, the data presenter 120 resizes and reshapes the first part, so as to fit the size and shape of the second article.

In another example, the data presenter 120 may automatically adjust the size of the first part of the GUI, upon a zoom-in or zoom-out operation by a user who views the data presented.

Optionally, the apparatus 100 also includes a configurator, in communication with the data presenter 120.

The configurator may be used by an authorized user, say an administrator of the apparatus 100 or a publisher of the presented data, for configuring the first part, say for setting the size and shape of the first part.

For example, the administrator may set physical dimensions for the first part (width, length, radius, etc.), the amount of data (say the number of data bytes or the number of text lines) the first part exposes at a time, or a combination thereof.

The administrator may also use the configurator, to define the shape of the first part, say oval like a spotlight, rectangular like a window, etc., as described in further detail hereinbelow.

Optionally, the apparatus 100 further includes a thumbnail presenter, in communication with the data presenter 120.

The thumbnail presenter generates and presents a thumbnail image of the data presented to the user, thereby assisting the user in navigating through the presented data, by moving the first part of the GUI.

Optionally, the second part of the graphical user interface blurs the remaining portion of the data presented on the screen, thereby disabling the free viewing, as described in further detail and illustrated hereinbelow.

Optionally, the second part of the graphical user interface hides the remaining portion of the presented data, at least partially, thereby disabling the free viewing, as described in further detail and illustrated hereinbelow.

Optionally, the second part of the graphical user interface hides the remaining portion of the presented data, partially, using geometrical figures, thereby disabling the free viewing, as described in further detail and illustrated hereinbelow.

For example, the free viewing of the remaining portion of the data may be carried out using one or more geometrical figures, such as spaced prison-like bars. The bars may be horizontal, vertical, diagonal, etc. The bars may have a varying width, a varying spacing, etc. The bars partially hide the remaining portion of the data presented on the screen, as described in further detail, and illustrated hereinbelow.

Optionally, the data presenter 120 presents moving content on the second part, say a moving textual background different than the received data's text. Consequently, the data presenter 120 disables the free viewing of the remaining portion of the received data, presented on the screen, as described in further detail and illustrated hereinbelow.

Optionally, when the user performs a predefined operation, the data presenter 120 avoids presenting of all received data through the graphical user interface. Optionally, the operation is defined in advance by an administrator of the apparatus 100.

In one example, upon the user's changing the operating system's focus from a word processor processing a document carrying the received data, to another application, the data presenter 120 hides all of the data presented on the screen. In the specific example, when the user switches from the word processor to a news web site page (or any other application), the data presenter 120 hides all the presented data.

Optionally, the data presenter 120 utilizes one or more relevant technologies, say ActiveX© or Adobe© Flash technologies, as known in the art. The relevant technologies include, but are not limited to: an event handler for losing or gaining focus (which hides the data presented when the user switches to the news web site), a browser plug-in which registers for application focus change events, etc., as known in the art.

Optionally, the data presenter 120 presents the received data through the graphical user interface only if the user performs a predefined operation.

In one example, the data presenter 120 presents the received data only if the user presses a certain key, as described in further detail and illustrated hereinbelow.

Optionally, the apparatus 100 further includes a clipboard eraser, in communication with the data presenter 120.

The clipboard eraser erases an operating system clipboard, thereby disabling a print screen computer operation when the received data is presented to the user.

Optionally, the clipboard eraser frequently erases the print screen clipboard (i.e. the operating system clipboard), and thereby prevents an operating system's print screen operation.

For example, the clipboard eraser may erase the print screen clipboard, by loading corrupt or null values into the operating system clipboard. In the example, the clipboard eraser erases the clipboard two hundred times in each second.

In another example, the clipboard eraser erases the clipboard on every user mouse click, when the user strikes a keyboard key, or when the user shifts from a computer application used to view the data to another computer application.

Optionally, the clipboard eraser utilizes one or more relevant technologies, say ActiveX© or Adobe© Flash technologies, as known in the art.

The relevant technologies include, but are not limited to: a Flash event handler for all mouse and keyboard events which sets the clipboard to a default string, a browser ActiveX© plug-in initiated thread which sets the clipboard to an empty (i.e. null) content, a browser ActiveX© plug-in global hotkey which listens for print screen key pressing and disables print screen operation initiated upon the pressing, etc., as described in further detail hereinbelow.

Optionally, the apparatus 100 further includes a function deactivator, in communication with the data presenter 120.

The function deactivator deactivates one or more predefined computer functions (say computer hotkeys), during the time period in which the received data is presented to the user.

The deactivated functions may include, but are not limited to: file saving, message forwarding, file renaming, copy and paste functions, etc., as known in the art.

Optionally, the function activator is implemented using one or more ActiveX© or Adobe© Flash technologies, such as registering an event handler for all mouse and keyboard events, which blocks some of the events, etc., as known in the art.

Optionally, the apparatus 100 is implemented as a part of a system which utilizes further means for securely presenting the received data. For example, the system may allow only authorized users to access the received data. The system may restrict different users with respect to different computer operations each of the users is allowed to execute on the received data, restrict sharing of the received data among different users, etc., as known in the art.

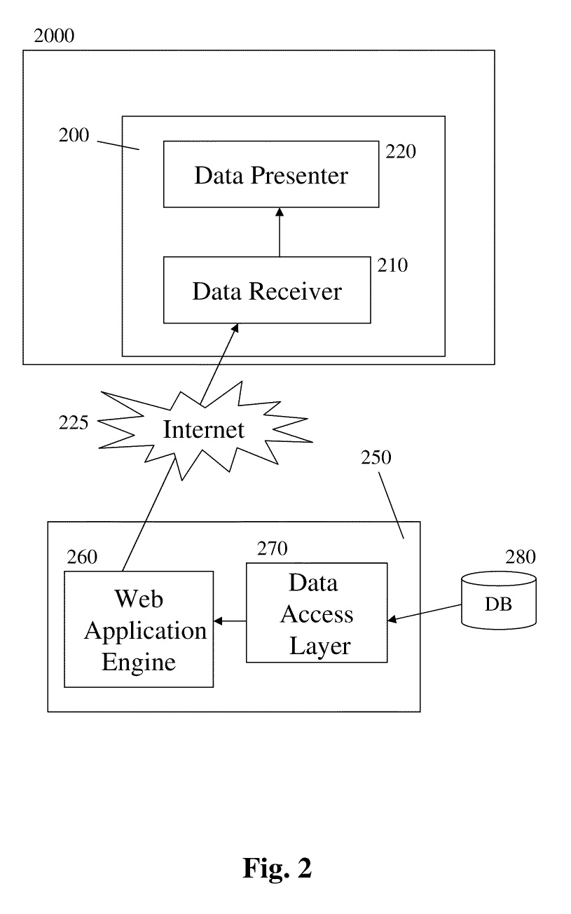

Reference is now made to FIG. 2, which is a block diagram schematically illustrating a second exemplary apparatus, for securely presenting data to a user, according to an exemplary embodiment of the present invention.

Exemplary apparatus 200 for securely presenting data to a user is implemented as a part of a standard internet browser 2000 (say Microsoft© Internet Explorer, Google©Chrome, etc.).

In an exemplary Software-as-a-Service (SaaS) model, the exemplary apparatus 200 is a part of a secure flash application downloaded to the standard browser 2000, in an encrypted form. Using the standard browser, there is avoided the use of a dedicated client program.

Optionally, the flash application is protected from hacking using a variety of technologies, such as code obfuscation, anti-debugging tools, etc., as known in the art.

The exemplary SaaS model may prove very suitable, for an organization which limits installation of client software on the organization's computers. The exemplary SaaS model also suits users of software or hardware platforms not compatible with a dedicated client program provided by a vendor.

Optionally, the apparatus 200 communicates with a remote server 250, over a network such as the internet 225, for receiving and securely viewing sensitive data, say by navigating through pages of a web site, and using one of the pages, for downloading the sensitive data, as described in further detail hereinbelow.

Apparatus 200 includes a data receiver 210.

The data receiver 210 sends a request to view the sensitive data, to a web application engine 260 deployed on the server 250, say using a dedicated web page, as described in further detail hereinbelow.

Per the request received from the data receiver 210, the web application engine 260 verifies that the user is authorized to view the sensitive data, say using a dedicated user authorization table, on a database 280, as known in the art. Upon finding the user authorized to view the sensitive data, the sensitive data is retrieved by a data access layer 270 (say a data base management system, as known in the art), say from the dedicated database 280.

The web application server 260 sends the sensitive data to the data receiver 210, in an encrypted format.

The apparatus 200 further includes a data presenter 220, in communication with the data receiver 210.

The data presenter 220 presents the received data to the user, on a screen (say a computer screen, a cellular phone screen, etc.) through a special graphical user interface (GUI).

The GUI includes a first part. The first part exposes only a portion of the data presented on the screen, say only two lines of text at a time.

The GUI further includes a second part. The second part disables free viewing of a remaining portion of the data presented on the screen.

The free viewing of the remaining portion of the presented data may be prevented by blurring the remaining portion, hiding the remaining portion (fully or partially), etc., as described in further detail hereinbelow.

Optionally, the first part is movable through the presented data and a user who views the presented data may operate the data presenter 220, for moving the first part, thereby exposing a different portion of the presented data through the first part.

Optionally, a remote user, say an authorized operator or a publisher of the data presented on the screen, may use the Web Application Engine 260, to communicate with the data presenter 220. The remote user may operate the data presenter 220, for moving the first part, as described in further detail hereinbelow.

For example, the first part may be moved between positions on the screen.

Alternatively, the first part may be moved through the presented data while staying in a fixed position on the screen, thus scrolling through the presented data.

The first part exposes only a portion of the presented data at a time. The exposed portion is freely viewable by the user, through the first part, while the presented data's remaining portion is obfuscated or obscured.

Optionally, the web application server 260 controls the presentation of the classified data to the user.

The application server 260 may remotely control the presentation, by instructing the data presenter 220 to present the classified data to the user using the special GUI, to present the data using a standard GUI (say using a regular Microsoft© Word graphical interface), etc.

In one example, the application server 260 controls the presentation, according to user specific authorization data stored in the database 280, as described in further detail hereinbelow.

Optionally, the web application server 260 further controls the second part's size (say the number of lines presented through the second part), the second part's shape, etc, as described in further detail hereinbelow.

Optionally, the web application server 260 remotely controls the presentation, by instructing the data presenter 220 to move the first part of the GUI, as described in further detail hereinabove.

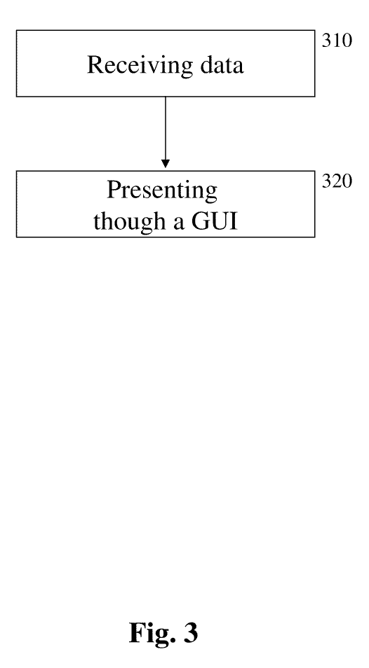

Reference is now made to FIG. 3, which is a flowchart schematically illustrating a first exemplary method, for securely presenting data to a user, according to an exemplary embodiment of the present invention.

A method for securely presenting data to a user, according to an exemplary embodiment of the present invention, may be implemented on apparatus 100, as described in further detail hereinabove.

The apparatus 100 may be implemented on a computer, say a laptop computer, a tablet computer, a cellular phone, etc, as described in further detail hereinabove.

Optionally, the method is implemented in a Software-as-a-Service (SaaS) mode, as described in further detail hereinabove.

In the exemplary method, there is received 310 data, to be presented to a computer user.

The data may include, but is not limited to: textual data (say content of a Microsoft© Word file or an html file), graphical content (say an electronic circuit diagram on a Power Point presentation file), etc.

The received 310 data is presented 320 to the user, say on a computer screen, through a special graphical user interface (GUI).

The GUI includes a first part, which exposes only a portion of the data presented on the screen. The GUI further includes a second part, which disables free viewing of one or more remaining portions of the presented data.

Optionally, the second part is implemented using Adobe© Flash technologies. An opaque texture graphical layer is drawn to obscure the data presented on the screen. The first part may be implemented, by drawing a blend-mode graphical layer on top of the previously drawn layer, as known in the art.

Optionally, the GUI is implemented by positioning an opaque texture graphical layer, with a transparent area (i.e. first part) on top of the whole desktop of the user's computer, say using an always-on-top window, as described in further detail hereinabove.

Optionally, the GUI is implemented by hooking certain Microsoft© Word events, or Microsoft© Windows events, as described in further detail hereinabove.

Optionally, the first part is movable through the presented data and a user who views the presented data may operate the data presenter 120, for moving the first part, thereby exposing a different portion of the presented data through the first part.

Optionally, a remote user, say an authorized operator, or a publisher of the data presented on the screen, may operate the data presenter 120, for moving the first part, as described in further detail hereinabove.

For example, a user may move the first part between positions on the screen, say using a computer mouse, or using arrow keys on a computer keyboard, thus exposing different portions of the data presented on the screen. Alternatively, the user may scroll the data through the first part, while the first part stays in a fixed position on the screen, etc.

As the first part moves through different portions of the presented data, the first part exposes the different portions of the data on the screen. As the first part moves, the second part of the graphical user interface disables free viewing of one or more remaining portions of the data presented on the screen.

That is to say that the first part exposes only a portion of the presented data at a time. The exposed portion is freely viewable by the user, through the first part, while the data's remaining portions are obfuscated or obscured.

The remaining portions are obfuscated or obscured by a concealing or blurring effect, caused by the second part of the graphical user interface. Consequently, there is prevented free viewing of the remaining portions by the user, as described in further detail hereinbelow.

Optionally, the amount of data exposed by the first part is limited by the size and shape of the first part, as described in further detail and illustrated hereinbelow.

Optionally, the exemplary method further includes automatically moving the first part, for exposing different portions of the data presented on the screen.

Optionally, the exemplary method further includes allowing the user to control movement of the first part. For example, the user may use arrow keys to control the direction of the first part, press a certain key to slow down or speed up the first part, press a tab key to jump over a portion of the data presented on the screen, etc.

Optionally, the method further includes moving the first part upon a successful string search operation initiated by the user (as known in the art), thus relocating the first part into a new position, thereby exposing a portion of the presented data in proximity of the string, through the first part.

For example, the method may be implemented using a plug-in to a Word Processor, say to Microsoft© Word.

Upon a successful search for a specific string in a Word (.doc) document, the first part is automatically moved through the document, and relocated into a position in proximity to the string, as found in the document.

Consequently, a text of the Word document, in proximity of the found string is freely viewable through the first part of the GUI. However, remaining parts of the document presented on the screen (say all remaining text, in the page where the string is found) are blurred by the second part of the GUI, as described in further detail, and illustrated hereinbelow.

Optionally, the method further includes deriving a structure of the received data. Consequently, the user is allowed to move the first part through a path. The path is based on the structure derived by the data structure deriver, as described in further detail hereinabove.

For example, the method may include deriving a structure of a textual file bearing the content of a classified intelligent report, by detecting changes in the document text. The changes may include font changes, page breaks, etc. The changes may be characteristic of headlines of articles in the classified intelligent report, new paragraphs, etc.

Consequently, the user may move the first part between the articles or paragraphs in the classified intelligent report. Optionally, the user operates the data presenter 120, for moving the first part between the articles or paragraphs, as described in further detail hereinabove.

The amount of data exposed by the first part may be limited by the size and shape of the first part, as described in further detail and illustrated hereinbelow.

For example, the first part may be oval (say like a spotlight), rectangular (say like a window), circular, square, etc. The first part may be limited to a fixed physical size, or to a certain amount of data, say to a predefined number of words, bytes, or text lines.

Optionally, an authorized user, say an administrator of the apparatus 100 or a publisher of the data presented on the screen, is allowed to configure the first part.

For example, the publisher may set physical dimensions for the first part (width, length, radius, etc.), define the amount of data (say the number of data bytes or the number of text lines) the first part exposes, etc.

The publisher may also be allowed to define the shape of the first part (wide oval, narrow oval, rectangular, square, etc.), as described in further detail hereinbelow.

Optionally, the method further includes generating and presenting a thumbnail image of the data presented on the screen, thereby assisting the user in navigating through the presented data.

Optionally, the second part of the graphical user interface blurs the remaining portion of the data presented on the screen, thereby disabling the free viewing of the remaining portion, as described in further detail and illustrated hereinbelow.

Optionally, the second part of the graphical user interface hides the remaining portion of the data presented on the screen, at least partially, thereby disabling the free viewing, as described in further detail and illustrated hereinbelow.

Optionally, the second part of the graphical user interface hides the remaining portion of the data presented on the screen, partially, using geometrical figures, thereby disabling the free viewing, as described in further detail and illustrated hereinbelow.

Optionally, the second part of the graphical user interface hides the remaining portion of the presented data, partially, using geometrical figures, thereby disabling the free viewing, as described in further detail and illustrated hereinbelow.

Optionally, there is presented a moving content on the second part.

For example, there may be presented a moving text different than text of the received data, on the second part of the GUI. Consequently, there is disabled free viewing of the remaining portion of the data presented on the screen, as described in further detail and illustrated hereinbelow.

Optionally, when the user performs a predefined operation, there is prevented free viewing of the data presented on the screen, as describe in further detail hereinbelow.

For example, if the user changes the operating system's focus from a word processor processing a document carrying the received data, to another application, all of the data on the screen is hidden. In the specific example, when the user switches from the word processor to a news web site page browsed using Google® Chrome, there is prevented free viewing of the data on the screen.

Optionally, the prevention of free viewing is triggered using one or more relevant technologies, say ActiveX© or Adobe© Flash technologies, as known in the art.

For example, the prevention may be trigged by a Flash event handler, for changing of the focus. When the user changes the focus, an opaque layer is drawn over the data presented on the screen.

In another example, the prevention is trigged by an ActiveX© browser plug-in, which upon the change in the focus, draws an opaque layer on the data presented on the screen, using standard Graphical Design Interface (GDI) Commands, as known in the art.

Optionally, in the exemplary method, the received data is presented through the graphical user interface, only upon a predefined operation's performance by the user. In one example, the received data is presented only if the user presses a certain key, as described in further detail and illustrated hereinbelow.

Optionally, the method further includes erasing an operating system clipboard, thereby disabling a print screen computer operation, when the received data is presented to the user.

For example, the clipboard eraser, described in further detail hereinabove, may frequently (say two hundred in each second, on every user mouse click, when the user strikes a keyboard key, etc.) erase the print screen clipboard (i.e. the operating system clipboard).

Optionally, the clipboard eraser utilizes one or more relevant technologies, say ActiveX© or Adobe© Flash technologies, as known in the art. The relevant technologies include, but not limited to: an event handler for all mouse and keyboard events which sets the clipboard to a default string, a browser plug-in initiated thread which sets the clipboard to an empty (i.e. null) content, etc., as described in further detail hereinbelow.

By erasing the clipboard, the clipboard eraser disables an operating system's print screen operation. Optionally, the clipboard is erased, by loading corrupt or null values into the operating system clipboard

Optionally, the exemplary method further includes deactivating one or more predefined computer functions, during the time period in which the received data is presented to the user.

The deactivated functions may include, but are not limited to: file saving, message forwarding, file renaming, copy and paste functions, etc., as known in the art.

Optionally, the functions are deactivated using one or more ActiveX© or Adobe© Adobe Flash technologies, such as registering an event handler for all mouse and keyboard events which blocks some of the events, etc., say using the function deactivator, as described in further detail hereinabove.

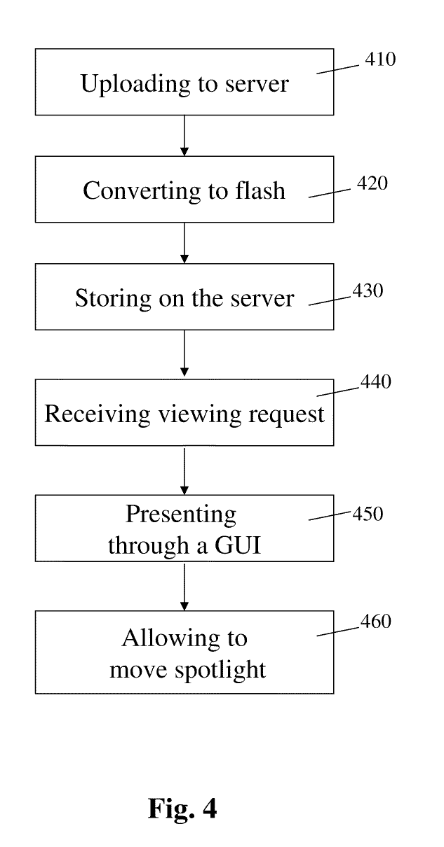

Reference is now made to FIG. 4, which is a flowchart schematically illustrating a second exemplary method for securely presenting data to a user, according to an exemplary embodiment of the present invention.

An exemplary method for securely presenting data to a user, according to an exemplary embodiment of the present invention, may be implemented on apparatus 200, as described in further detail hereinabove.

Optionally, the exemplary method is implemented in a Software-as-a-Service (SaaS) mode, using a remote server the user communicates with.

The user may use a standard web browser, such as Microsoft© Internet Explorer, Google© Chrome, Mozilla Firefox, etc., without installing dedicated client software, as described in further detail hereinabove.

In the exemplary method, a file containing sensitive data may be uploaded 410 to a server via an encrypted communication session, say using HTTPS (Hypertext Transfer Protocol Secure).

Next, the data file is converted 420 into a flash format such as Small Web Format (SWF), as know in the art. In one example, the data file is a Microsoft© Word document and the server converts the data file into Portable Document Format (PDF) first, and then into SWF, using conventional techniques, as known in the art.

The data is encrypted and stored 430 on the server.

Next, there is received 440 a request to view the sensitive data, from a remote user in communication with the server, say using a standard web browser, as described in further detail hereinabove. For example, the remote user may use the browser, to navigate through pages of a web site. Then, the remote user requests to download a sensitive document, using one of the web site's pages, as known in the art.

Per the request received 440 from the remote user, there is verified that the remote user is authorized to view the sensitive document. Upon finding the remote user authorized to view the document, the sensitive data is presented 450 to the remote user, through a special Graphical User Interface (GUI), as described in further detail hereinabove.

More specifically, the sensitive data is downloaded to a secure flash application implemented on the user's web browser, in an encrypted format, as described in further detail hereinabove.

Optionally, the flash application is protected from hacking using a variety of technologies, such as code obfuscation, anti-debugging tools, etc., as known in the art.

The special GUI includes a first part. The first part exposes only a portion of the data presented on the screen, say only two lines of text at a time. Optionally, the first part is in a shape of an oval spotlight, as described in further detail hereinabove.

The GUI further includes a second part. The second part disables free viewing of a remaining portion of the data presented on the screen.

The free viewing of the remaining portion of the presented data may be prevented by blurring the remaining portion, hiding the remaining portion (fully or partially), etc., as described in further detail hereinbelow.

For example, the free viewing of the remaining portion of the presented data may be carried out using one or more geometrical figures, such as spaced prison-like bars. The bars partially hide the remaining portion of the data presented on the screen, as described in further detail, and illustrated hereinbelow.

Consequently, an image of a computer screen used to present the data, as captured using a device external to the computer (say a still camera), shows only a portion of the data presented on the screen.

Further, a hiding or blurring effect applied on the remaining portion of the data presented on the screen, may serve as incriminating evidence against a person in possession of an image of the screen, as captured by the still camera, as described in further detail hereinbelow.

For example, the second part of the GUI may be implemented as a graphical layer, which covers and blurs the remaining portions of the data, and includes a watermark. Optionally, the watermark includes an email address or another detail, which identifies the user. A person in possession of an image of the screen may thus be incriminated, together with the user whose detail is included in the watermark.

Optionally, the second part is implemented as a covering layer, which prevents free viewing of the entire data presented on the screen, say using an opaque texture, applied using Adobe© Flash technologies, as known in the art. The first part may be implemented as an exposing layer. The exposing layer erases the covering layer at a screen area of the screen, thus exposing only a portion of the data, for free viewing by the user.

Optionally, the graphical user interface is implemented as an always on top window, in Microsoft© Windows Operating System, as known in the art.

Optionally, the user of the web application may further be allowed 460 to move the spotlight (i.e. first part), through the data presented on the screen, thus exposing a different portion of the sensitive data at a time, as described in further detail hereinabove.

Optionally, a remote user, say an authorized operator, or a publisher of the data presented on the screen, may remotely operate the data presenter 120, for moving the first part, as described in further detail hereinbelow.

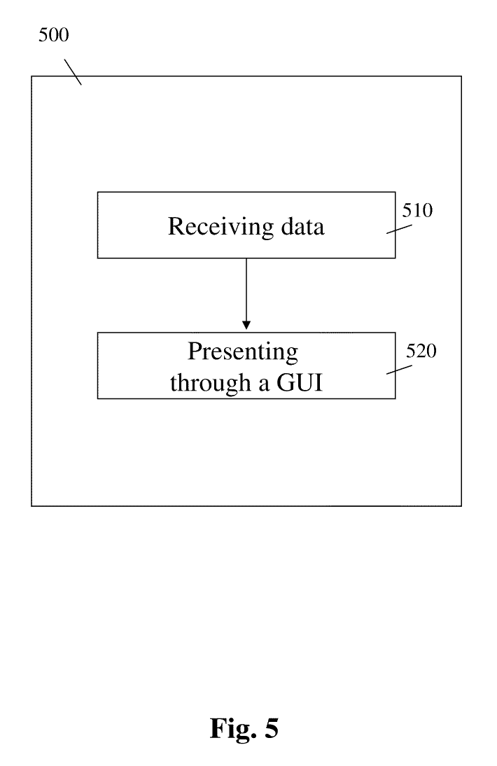

Reference is now made to FIG. 5, which is a block diagram schematically illustrating a computer readable medium storing computer executable instructions for performing steps of securely presenting data to a user, according to an exemplary embodiment of the present invention.

According to an exemplary embodiment of the present invention, there is provided a computer readable medium 500, such as a CD-ROM, a USB-Memory, a Portable Hard Disk, a diskette, etc.

The computer readable medium stores computer executable instructions, for performing steps of securely presenting data to a user, according to an exemplary embodiment of the present invention.

The computer executable instructions include a step of receiving 510 the data.

The data may include, but is not limited to: textual data (say content of a Microsoft© Word file or an html file), graphical content (say an electronic circuit diagram on a Power Point presentation file), etc.

The instructions further include a step of presenting 520 the received 510 data to the user, on a screen (say a computer screen or a cellular phone screen), through a special graphical user interface (GUI).

The special graphical user interface includes a first part, which exposes only a portion of the data presented on the screen. The graphical user interface also includes a second part, which disables free viewing of a remaining portion of the presented data, as described in further detail hereinabove.

Consequently, there may be prevented data-leakage by screen-capture, as described in further detail hereinbelow.

Optionally, the first part is movable through the data.

For example, the instructions may allow a user who views the presented data, to move the first part, for exposing a different portion of the data presented on the screen, through the first part, as described in further detail hereinabove.

Optionally, the instructions allow a remote user (say an authorized operator, or a publisher of the data presented on the screen) to move the first part, for exposing a different portion of the data presented on the screen, as described in further detail hereinbelow.

As the first part moves through different portions of the presented data, the first part exposes different portions of the data presented on the computer screen. As the first part moves, the second part of the graphical user interface disables free viewing of the remaining portion of the data presented on the screen.

That is to say that the first part exposes only a portion of the data at a time. The exposed portion is freely viewable by the user, through the first part, while the data's remaining portion is obfuscated or obscured.

Optionally, the remaining portion is obfuscated or obscured by a concealing or blurring effect, caused by the second part of the graphical user interface, thus preventing the second parts' free viewing by the user, as described in further detail hereinabove.

Optionally, the instructions further include a step for automatically moving the first part, for exposing different portions of the data presented on the screen.

Optionally, the instructions further allow a user to control movement of the first part.

For example, the user who views the presented data may use arrow keys to control the direction of the first part, press a certain key to slow down or speed up the first part, press a tab key to jump over a portion of the data presented on the screen, etc., as described in further detail hereinabove.

Optionally, the instructions further include a step for moving the first part upon a successful string search operation initiated by the user (as known in the art), thus relocating the first part. Consequently, there is exposed a portion of the data presented on the screen, in proximity of the found string, through the first part, as described in further detail hereinabove.

Optionally, the instructions further include a step for deriving a structure of the received data. Consequently, the instructions allow to user to move the first part through a path. The path is based on the structure derived by the data structure deriver, as described in further detail hereinabove.

The amount of data exposed by the first part may be limited by the size and shape of the first part of the graphical user interface, as described in further detail and illustrated hereinabove.

For example, the first part may be oval, rectangular, etc., and limited to a fixed physical size, or to an amount of data (say words, bytes, or text lines) the first part exposes.

Optionally, the instructions allow an authorized user, say an administrator of apparatus 100 or a publisher of the data presented on the screen (say a military institution who publishes an intelligence report), to configure the first part, as described in further detail hereinabove.

For example, the administrator may set physical dimensions for the first part (width, length, radius, etc.), define the amount of data (say the number of data bytes or the number of text lines) the first part exposes, define the shape of the first part, etc.

Optionally, the second part of the graphical user interface disables the free viewing of the remaining portion of the data presented to the user, by blurring the remaining portions, by hiding the remaining portions of the presented data (partially of fully), using a moving text presented on the second part, etc., as described in further detail hereinabove.

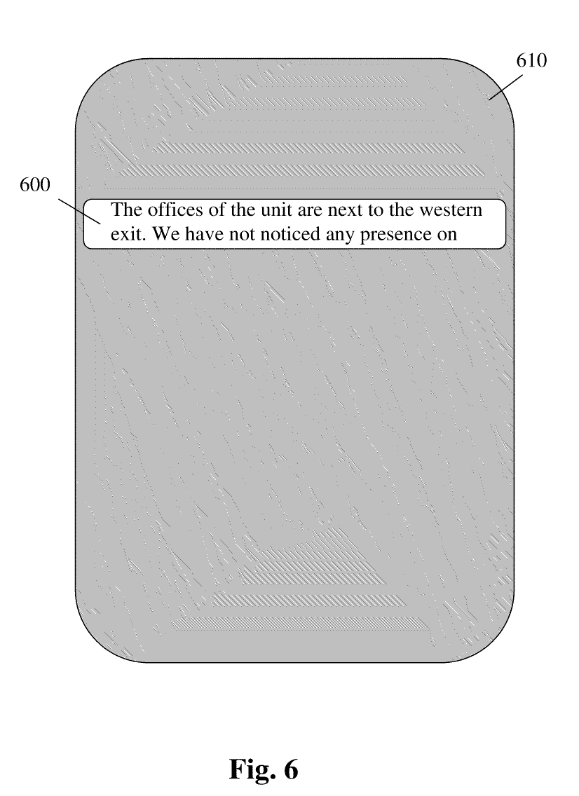

Reference is now made to FIG. 6, which is a block diagram schematically illustrating a first exemplary Graphical User Interface, for securely presenting data to a user, according to an exemplary embodiment of the present invention.

According to exemplary embodiments of the present invention, data (say textual content of a Microsoft© Word file, graphical content of an electronic circuit diagram on a graphical file, etc.) is presented to a user on a screen, through a special Graphical User Interface (GUI).

The screen may be a desktop computer screen, a laptop computer screen, a screen of a tablet computer, a cellular phone screen, etc, as known in the art.

An exemplary special GUI includes a first part 600. The first part 600 has a rectangular, window-like shape. The first part exposes only a portion of the data presented on the screen, say only two lines of text at a time.

The GUI further includes a second part 610. The second part 610 disables free viewing of a remaining portion of the data presented on the screen.

Optionally, the second part 610 prevents the free viewing of the remaining portion of the data, by blurring the remaining portion, as described in further detail hereinabove.

Optionally, the second part 610 prevents the free viewing, by hiding the remaining portion (fully or partially), etc., as described in further detail hereinbelow.

Optionally, there is presented a moving content on the second part, say a moving textual background different than the received data's text. Consequently, the second part 610 disables the free viewing of the remaining portion of the received data presented on the screen, as described in further detail hereinabove.

When a user views the data presented on the screen, through the graphical user interface, the user's human eye easily separates the fixed data exposed through the first part 600, from the moving textual background on the second part 610.

However, a user who examines a still image of the screen, captured by an external device (such as a still camera), is likely to find it difficult to separate the data exposed through the first part 600 from the (now still) background presented on the second part 610.

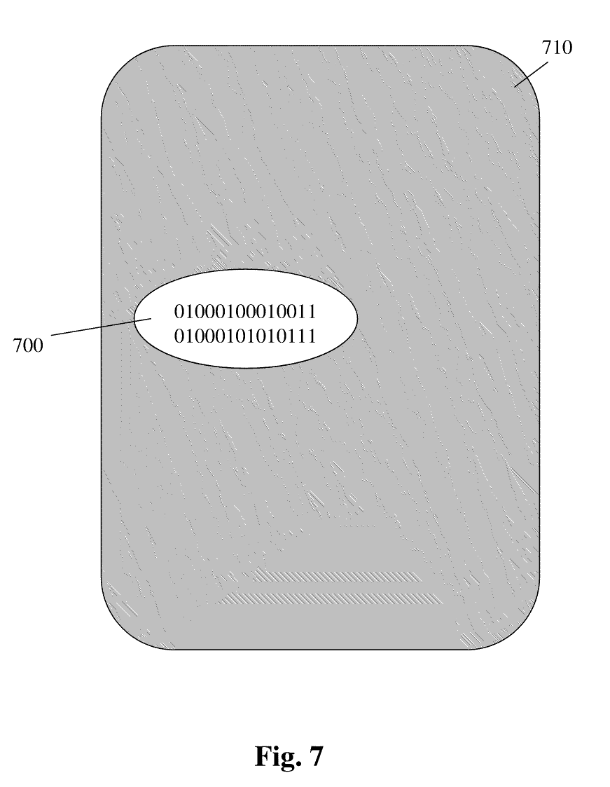

Reference is now made to FIG. 7, which is a block diagram schematically illustrating a second exemplary Graphical User Interface, for securely presenting data to a user, according to an exemplary embodiment of the present invention.

According to exemplary embodiments of the present invention, data (say textual content of a Microsoft© Word file, graphical content of an electronic circuit diagram on a graphical file, etc.) is presented to a user on a screen, through a special Graphical User Interface (GUI).

An exemplary special GUI includes a first part 700. The first part 700 has an oval, spotlight shape. The first part exposes only a portion of the data presented on the screen, say only a certain number of text characters, or a certain number of data bytes.

The GUI further includes a second part 710. The second part 710 disables free viewing of a remaining portion of the data presented on the screen.

Optionally, the second part 710 prevents the free viewing of the remaining portion of the data, by blurring the remaining portion, as described in further detail hereinabove.

Optionally, the second part 710 prevents the free viewing, by hiding the remaining portion (fully or partially), etc., as described in further detail hereinbelow.

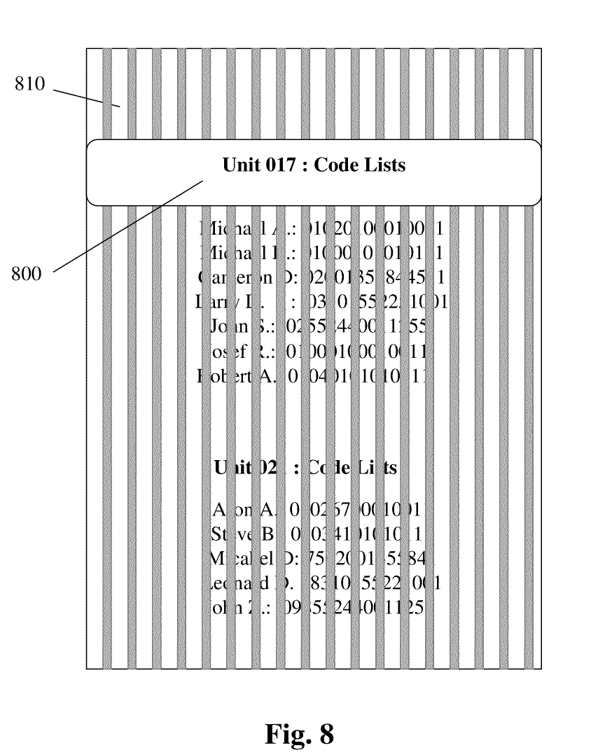

Reference is now made to FIG. 8, which is a block diagram schematically illustrating a third exemplary Graphical User Interface, for securely presenting data to a user, according to an exemplary embodiment of the present invention.

According to exemplary embodiments of the present invention, data (say textual content of a Microsoft© Word file, graphical content of an electronic circuit diagram on a graphical file, etc.) is presented to a user on a screen, through a special Graphical User Interface (GUI).

The screen may be a desktop computer screen, a laptop computer screen, a screen of a tablet computer, a cellular phone screen, etc, as known in the art.

An exemplary special GUI includes a first part 800. The first part 800 has a rectangular, window-like shape. The first part exposes only a portion of the data presented on the screen at a time, say only two lines of text, a certain number of characters, or a certain number of data bytes.

The GUI further includes a second part 810. The second part 810 disables free viewing of a remaining portion of the data presented on the screen.

The second part 810 prevents the free viewing, by partially hiding the remaining portion of the data presented on the screen.

In the exemplary GUI, the second part 810 includes one or more geometrical figures, such as spaced prison-like bars. The bars may be horizontal or vertical. The bars may have a varying width, a varying spacing, etc.

Like a prisoner behind bars, the remaining portion of the data presented on the screen, is hidden, but only partially. Consequently, a user may still see the general structure of the data (i.e. document) presented on the screen, and navigate through the data. However, a full capture of the data presented on the screen, using an external device (such as a still camera) may be prevented.

Optionally, an authorized user, such as an administrator of apparatus 100 or a publisher of the data presented on the screen, is allowed to configure the shape, size and spacing of the geometrical figures of the second part 810. For example, the authorized user may use the data presenter 120 of apparatus 100, for configuring the shape, size or spacing of the geometrical figures, as described in further detail hereinabove.

Optionally, the user is allowed to move the rectangular, window-like shaped first part 800, as described in further detail hereinabove.

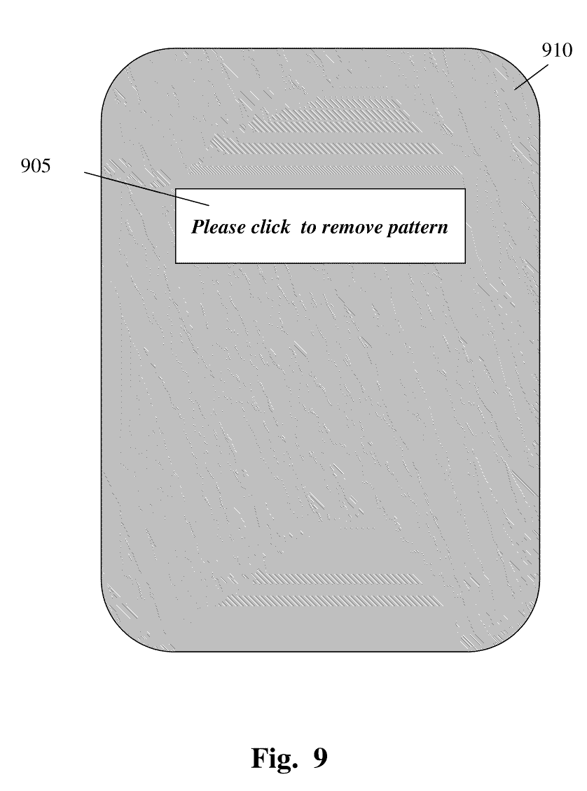

Reference is now made to FIG. 9, which is a block diagram schematically illustrating a fourth exemplary Graphical User Interface, for securely presenting data to a user, according to an exemplary embodiment of the present invention.

Optionally, in the exemplary method, the received data is presented through the graphical user interface, only upon a predefined operation's performance by the user. In one example, the received data is presented only if the user presses a certain key, as described in further detail and illustrated hereinbelow.

For example, the user may be asked to click the mouse, using a message box 905 presented on layer 910. The layer 910 blurs or hides, at least a portion of the data presented on the screen, until the user clicks the mouse.

When the user clicks the mouse, the data is presented on the screen, through a special graphical user interface (GUI).

The special GUI may includes a first part, which exposes only a portion of the data presented on the screen at a time, say only two lines of text and a second part. The second part disables free viewing of a remaining portion of the data presented on the screen, as described in further detail hereinabove.

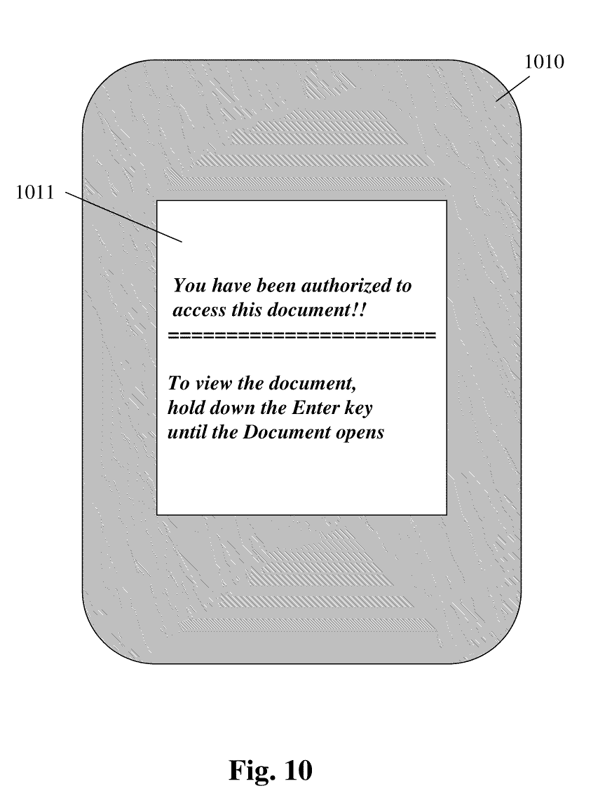

Reference is now made to FIG. 10, which is a block diagram schematically illustrating a fifth exemplary Graphical User Interface, for securely presenting data to a user, according to an exemplary embodiment of the present invention.

Optionally, in the exemplary method, the received data is presented through the graphical user interface, only upon a continuous operation's performance by the user.

Optionally, the data presenter 120 of apparatus 100, described in further detail hereinabove, uses an ActiveX© event handler which records the time in which the key is pressed down. A background thread checks the last time recorded by the event handler. Upon elapsing of more than half a second from the last time, the data presenter 120 hides the data presented on the screen, as described in further detail hereinabove.

In one example, the user may be asked to hold down the enter key, using a message box 1011 presented on layer 1010, until the data presenter 120 successfully completes certain initialization actions, say for blocking certain computer functions.

The layer 1010 blurs or hides, at least a portion of the data presented on the screen, until the data presenter 120 completes the initialization actions successfully. Further, the data presenter 120 carries out the initialization actions, only as long as the enter key is held down.

When the data presenter 120 completes the initialization actions, the data is presented on the screen, through a special graphical user interface (GUI).

The special GUI may includes a first part, which exposes only a portion of the data presented on the screen at a time, say only two lines of text and a second part. The second part disables free viewing of a remaining portion of the data presented on the screen, as described in further detail hereinabove.

In a second example, the received data is presented only as long as the user holds downs a certain key. When the user releases the key, the layer 1010 hides or blurs the data presented on the screen.

Optionally, the data is presented to the user, only as long as the user holds down two or more keys, thus preventing the user from holding a camera and taking a still image of the screen.

It is expected that during the life of this patent many relevant devices and systems will be developed and the scope of the terms herein, particularly of the terms “Screen”, “Mouse”, “Keyboard”, “Key”, “Computer”, “Cellular Phone”, “Browser”, “Internet”, “Operating System”, “Server”, “Client” and “Word Processor”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An apparatus for securely presenting data to a user, the apparatus comprising:
a data receiver, configured to receive the data; and
a data presenter, associated with said data receiver, configured to present the received data to the user on a screen, through a graphical user interface comprising a first part exposing only a portion of the presented data and a second part disabling free viewing of a remaining portion of the presented data.

2. The apparatus of claim 1, wherein said data presenter is further operable for moving said first part, thereby exposing a different portion of the presented data through said first part.

3. The apparatus of claim 1, wherein said data presenter is further configured to automatically move said first part, for exposing different portions of the presented data.

4. The apparatus of claim 1, wherein said data presenter is further configured to relocate said first part upon a successful string search operation initiated by the user, for exposing a portion of the presented data, in proximity of the string, through said first part.

5. The apparatus of claim 1, further comprising a data structure deriver, associated with said data receiver and configured to derive a structure of the received data, wherein said data presenter is further operable for moving said first part through a path based on the derived structure.

6. The apparatus of claim 1, further comprising a configurator, associated with said data presenter and operable for configuring said first part.

7. The apparatus of claim 1, further comprising a thumbnail presenter, associated with said data presenter, configured to generate and present a thumbnail image of the presented data to the user, for assisting the user in navigating through the presented data.

8. The apparatus of claim 1, wherein said second part blurs the remaining portion of the presented data, for disabling said free viewing.

9. The apparatus of claim 1, wherein said second part hides the remaining portion of the presented data, at least partially, for disabling said free viewing.

10. The apparatus of claim 1, wherein said second part hides the remaining portion of the presented data, partially, using geometrical figures, for disabling said free viewing.

11. The apparatus of claim 1, wherein said data presenter is further configured to present moving content on said second part, thereby disabling said free viewing of the remaining portion of the presented data.

12. The apparatus of claim 1, wherein said data presenter is further configured to avoid said presenting the data upon a predefined operation being performed by the user.

13. The apparatus of claim 1, wherein said data presenter is further configured to present the received data through the graphical user interface only upon a predefined operation being performed by the user.

14. The apparatus of claim 1, wherein said data presenter and data receiver are implemented in a Software-as-a-Service (SaaS) mode.

15. The apparatus of claim 1, further comprising a clipboard eraser, associated with said data presenter, configured to erase an operating system clipboard, for disabling a print screen computer operation.

16. The apparatus of claim 1, further comprising a function deactivator, associated with said data presenter, configured to deactivate at least one predefined computer function.

17. A computer implemented method for securely presenting data to a user, the method comprising steps the computer is programmed to perform, the steps comprising:
receiving the data; and
presenting the received data to the user on a screen, through a graphical user interface comprising a first part exposing only a portion of the presented data and a second part disabling free viewing of a remaining portion of the presented data.

18. The method of claim 17, further comprising moving said first part, for exposing a different portion of the presented data through said first part.

19. The method of claim 17, further comprising automatically moving said first part, for exposing different portions of the presented data.

20. A computer readable medium storing computer executable instructions for performing steps of securely presenting data to a user, the steps comprising:
receiving the data; and
presenting the received data to the user on a screen, through a graphical user interface comprising a first part exposing only a portion of the presented data and a second part disabling free viewing of a remaining portion of the presented data.
